(19) United States
(12) Patent Application Publication
(10) Pub. No.: US 2020/0154681 A1
(43) Pub. Date: May 21, 2020

(54) APPARATUS AND METHOD TO REDUCE EXPOSURE TO WATER BORNE PATHOGENS IN A POULTRY GROWING FACILITY

(71) Applicant: Poultry EcoServices, LLC, Annapolis, MD (US)

(72) Inventor: Rafael Sepulveda CORREA, Berlin, MD (US)

(21) Appl. No.: 16/196,334

(22) Filed: Nov. 20, 2018

(51) Int. Cl. A01K 39/02; F16L 9/02

(52) U.S. Cl. CPC A01K 39/0213; F16L 9/02

(57) ABSTRACT

A system and method for delivering a water supply to a poultry flock includes a water supply line including at least one perforation; a nipple drinker connected with the water supply line at each perforation; a water flow delivered from the nipple drinker; and a pathogen inhibiting material associated with at least one wetted component of at least one of the water supply line and the nipple drinker, whereby delivery of water through the system reduces flock exposure to water borne pathogens.

### BACKGROUND OF THE INVENTION

With increased consumer demand for antibiotic-free food animal production, poultry growers face new challenges to maintain flock viability and remain commercially competitive. These challenges include control of housing environmental conditions, litter quality, feed quality, and, especially, water quality. Variations in temperature and humidity can heighten these challenges.

Nipple drinkers are used in poultry husbandry to provide drinking water that is free of dust, dander and feathers. The potential, however, remains for the development of water-borne biological contaminants within the water supply lines to which the nipple drinkers are attached.

The slow laminar flow of water within long water supply lines that are exposed to warm temperatures creates ideal conditions for the proliferation of bacteria. When bacteria colonize and attach themselves to the interior wall of a water supply line, a sticky, jelly-like substance is exuded in the form of a membrane called biofilm.

As biofilm accumulates, segments of a colony can become detached from interior walls of a water supply line and be carried by the water flow into a nipple drinker, causing nipple drinker failure, either by blocking water flow or by preventing proper scaling of the nipple drinker valve, producing a constant leak. In addition, an improperly functioning nipple drinker can introduce other moisture related problems into a poultry house.

The effects of biofilm development are numerous.

Pathogens thrive and colonize in the biofilm due to ideal moisture and temperature conditions. As a result, hygienic water supplied to a poultry house can become contaminated before reaching the flock. These pathogens can spread diseases that severely challenge the health and performance of the flock.

Poultry that consumes biofilm contaminated water can suffer multiple digestive system problems which hinder growth performance and/or lead to development of watery feces (diarrhea). The contaminated feces, now resident on the poultry house floor, spreads to other birds within the poultry house. The cascading effect diminishes the health of the flock. Ammonia production is increased, thereby causing paw dermatitis that reduces a flock's commercial value.

Nipple drinkers are shared by multiple birds. Depending upon species, growth stage, temperature, ventilation, size of poultry house and other factors, the typical set up is one nipple drinker per 8-30 birds, creating another source of cross-contamination. During a flock grow-out period, nipple drinkers are exposed to an environment that promotes virus and bacteria proliferation—moisture, temperature, manure dust and nutrients. Unfortunately, deteriorating conditions are not readily visible to a flock's caretaker and are, therefore, typically addressed when time is available, or after a flock's health and performance are impacted.

Techniques for managing a flock's health include regular flushing of water lines. Flushing not only helps to remove some debris and particulate matter from water supply lines, it also helps to introduce cooler water into the system. While this can be completed once per week or even multiple times per day, such methods can increase labor, equipment, production and/or maintenance costs.

While the incorporation of antibiotics in poultry feed minimizes the negative effects of water contamination and pathogen development, consumer demand for antibiotic free production has increased. There is, therefore, a need to identify alternative solutions to the biological challenges faced by the commercial poultry industry.

In addition, current poultry watering system cleaning methods include the use of chemicals to flush water lines and do not adequately address all the above-mentioned issues. Moreover, these methods are always performed after the fact since regulations of the U.S. Environmental Protection Agency (EPA) restrict use of cleaning chemicals during a flock grow-out period.

### SUMMARY OF THE INVENTION

Embodiments of the present invention provide a comprehensive improvement to water supply lines and drinking systems commonly found within poultry growing facilities. These allow growers to maximize the use of existing equipment.

More particularly, pathogen inhibiting materials are introduced into existing or newly constructed poultry watering systems. In a preferred embodiment, the pathogen inhibiting material is copper. In another embodiment, water supply lines and/or nipple drinkers are constructed from copper. In an alternative embodiment, the pathogen inhibiting material is introduced into water supply lines.

### BRIEF DESCRIPTION OF THE DRAWINGS

The various aspects, features and advantages of the disclosure will become apparent from a study of the following description when viewed in the light of the accompanying drawings, in which:

FIG. 1 is a plan view of a poultry watering system including a water supply line and nipple drinker;

FIG. 2 is perspective view of a water supply line and nipple drinking system according to the disclosure; and

FIG. 3 is a cross-section of the embodiment of FIG. 2 taken along line 3-3.

FIG. 4 is a cross-section of the embodiment of FIG. 3 taken along line 4-4.

### DETAILED DESCRIPTION

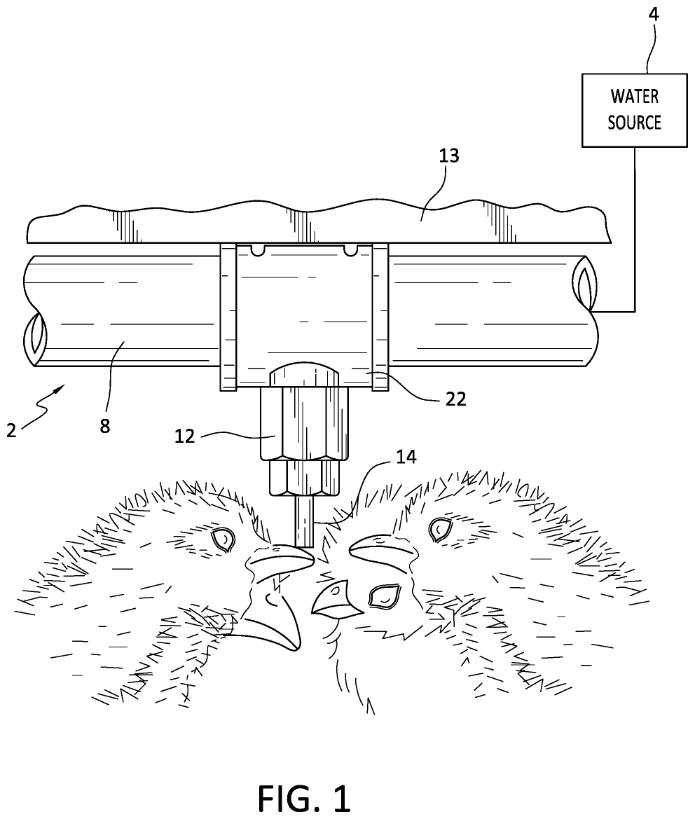

As shown in FIGS. 1-3, a nipple drinking watering system 2 includes a flexible water supply 4, a water supply line 8 including a plurality of perforations 10 for receiving a plurality of nipple drinkers 12, typically located on 8 inch (20.32 cm) centers and extending approximately 100 feet to 150 feet (30.48 m to 45.72 m) in length. A water pressure regulator may be provided in the supply line if desired. Water supply lines 8, typically constructed from polyvinyl chloride (PVC) and/or chlorinated polyvinyl chloride (CPVC), are attached to a suspension system 13, typically an aluminum extrusion that provides rigidity and a mechanism for suspending the supply lines 8 at variable heights according to poultry size.

The water supply lines 8 contain perforations 10 and support a saddle 22 for either permanently or removably connecting a nipple drinker 12 to the line. Where a saddle 22 is not used, a nipple drinker 12 is connected directly to a water supply line 8. In use, the perforation 10 is aligned with a through opening 24 in the nipple drinker so that water 20 can flow from the water supply line 8 to the nipple drinker 12 and to the flock.

Nipple drinkers 12 include a valve mechanism 15 for regulating water flow. In use, a bird contacts an actuator pin, trigger or tip 14 descending from the nipple drinker 12, breaking the water seal within the nipple drinker 12, thereby releasing regulated water droplets directly to a bird or birds and minimizing overspill which can accelerate contamination of a poultry house floor.

According to industry standards, the internal components of nipple drinkers are constructed from all stainless steel components or from a combination of stainless steel and synthetic plastic components, for example PCV and CPVC.

At the end of a flock grow-out period, the flock is removed from a poultry house and water supply lines 8 are raised close to the ceiling. Although the water source 4 is turned off and water is drained from the supply lines 8, static pockets of water may remain within water supply lines 8 due to variations in water supply tine 8 height. Supply lines 8, when raised close to the ceiling of a poultry house, can be exposed to warm temperatures for a period of 14 to 21 days, ample time for pathogen and biofilm development.

During this period, the metal actuator tips 14 of nipple drinkers 12 (with which birds must make contact in order to drink) are exposed to copious amounts of feces dust produced during inter-flock litter treatments such as crusting, windrowing and pulverizing.

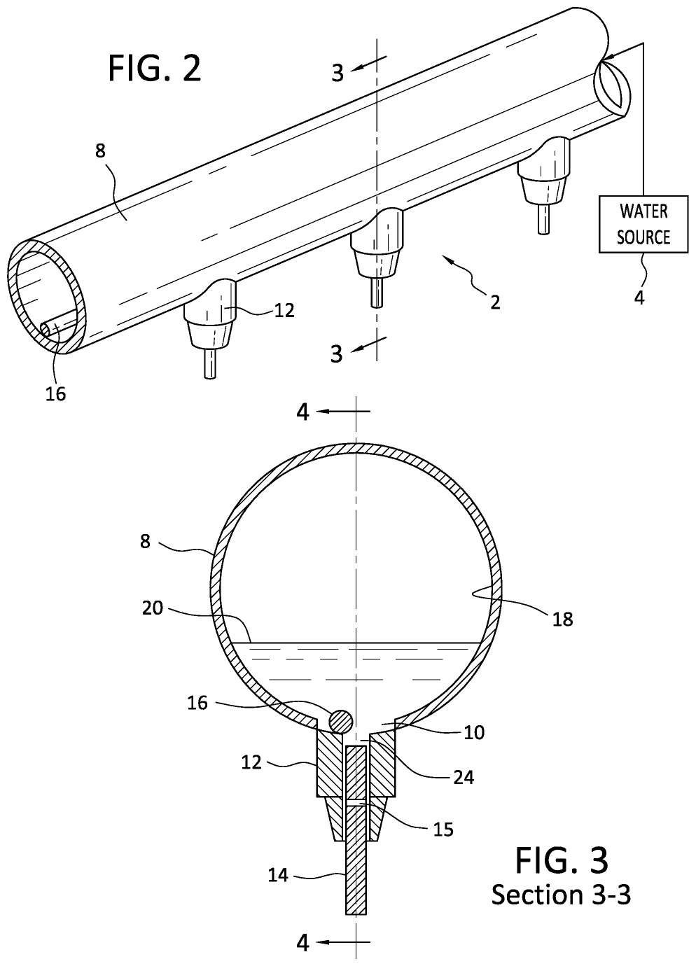

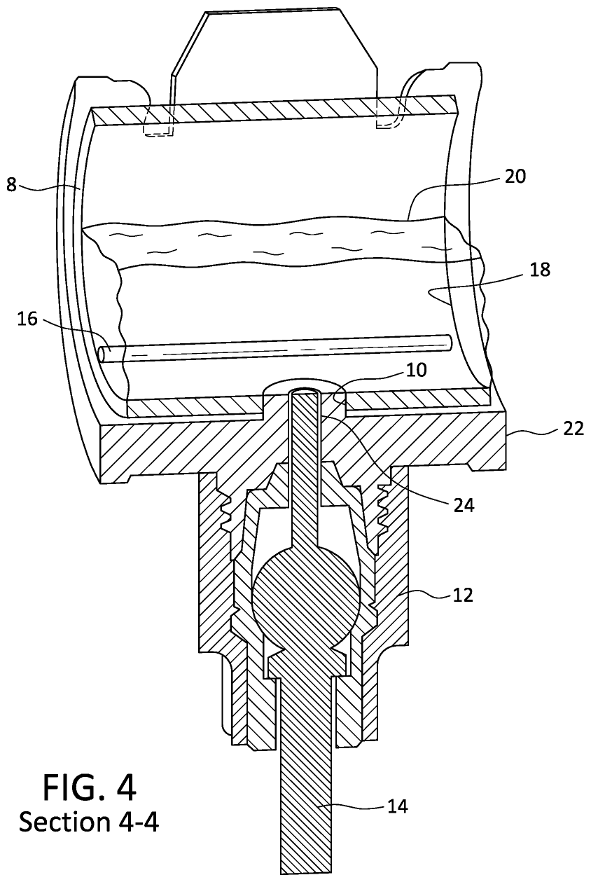

To reduce exposure to water borne pathogens, a pathogen inhibiting material 16 is added to the watering system 2 as shown in FIGS. 2 and 3. The pathogen inhibiting material 16 may include a material having natural bacteriostatic, anti fungal, antimicrobial and/or anti-biofouling properties. In accordance with embodiments of the invention, the pathogen inhibiting material 16 will neither react with mineral deposits found in the water contained within the system 2 nor promote corrosion of system 2 components. Advantageously, usage of the pathogen inhibiting material 16 will not require flushing of the water system 2 in order to comply with government standards before water may be delivered to a flock. Accordingly, the pathogen inhibiting material 16 can be utilized during delivery of water to a flock.

Preferably, introduction of the pathogen inhibiting material 16 into the watering system 2 will maximize usage of existing poultry house equipment. This will allow current techniques for the delivery of flock vitamin, mineral and nutritional supplements to be maintained. Accordingly, dietary plans for flocks need not be interrupted nor will flushing of the water system 2 be required before water can be delivered to a flock. In fact, the inventive watering system can supplement existing flock health maintenance techniques.

In a preferred embodiment, the pathogen inhibiting material 16 is copper. Copper includes natural properties capable of destroying a wide range of microorganisms (e.g., E. coli O157:H7, methicillin-resistant Staphylococcus aureus (MRSA), Staphylococcus, Clostridium difficile, influenza A virus, Adenovirus and fungi as well as stop or reduce incidence of cross-contamination.

To improve durability, the pathogen inhibiting material is heat treated to half or full hardness.

According to another embodiment, the pathogen inhibiting material is silver. In a further embodiment, the pathogen inhibiting material is a stainless steel and silver composite or other pathogen inhibiting material.

In another embodiment, the watering system 2 employs copper water supply lines 8. Alternatively, conventional watering systems could be implemented through the addition of copper material 16 into the interior 18 of the water supply line 8. The copper material 16 could be in the form of a length of copper wire, rod, ribbon, sheeting or the like, which is inserted into the water supply line 8. The copper material 16 may be solid copper, copper alloy or copper plated. In an alternative embodiment, the copper material is a liner insert (not illustrated) placed inside the water supply line 8. In a further alternative, the copper material 16 is in the form of a coil (not illustrated) inserted into the water supply line 8. In a further alternative, the copper material 16 is a mesh or screen. The mesh or screen could be placed at various junctions within the watering system 2, such as at the initial point of water entry into the system 2, at junctions between one or more water supply lines 8, or at perforations 10 which receive nipple drinkers 12.

The addition of copper material 16 to the water supply line 8 will neither obstruct nor impede a flow of water 20 within the water supply line 8 nor impede the flow of water 20 from the water supply line perforation 10 to the nipple drinker 12 through opening 24.

While some existing nipple drinker systems permit the nipple drinker to penetrate an interior diameter 18 of a water supply line 8, it is instead preferable that nipple drinkers 12 not penetrate an interior diameter 18 of water supply line 8, as this can increase flow resistance and potentially create pockets of stagnated water prone to biofilm formation.

In a further embodiment, nipple drinker 12 components are constructed from copper, copper alloy or copper plated material. Alternatively, a nipple drinker 12 actuator pin 14 is constructed front copper, copper alloy or copper plated material.

According to a method for delivering a water supply 4 to a poultry flock, a water supply line 8 is provided for delivering a metered flow of water 20 from the water supply line 8 to the poultry flock, and a pathogen inhibiting material 16, such as copper, is associated with at least one of the water supply line 8 and the metered flow of water 20. The metered flow can be delivered by a nipple drinker 12.

In one embodiment, the copper may be incorporated into a water supply line 8 and/or in the nipple drinker 12. Alternatively, a copper strip may be inserted or arranged within the water supply line 8.

While the present invention has been described with reference to one or more particular embodiments, those skilled in the art will recognize that many changes may be made thereto without departing from the spirit and scope of the present invention. Furthermore, components front one embodiment can be used in other non-exclusive embodiments. Each of these embodiments and obvious variations thereof is contemplated as falling within the spirit and scope of the invention.

1. A system for delivering a pathogen-inhibited water supply to a poultry flock comprising:
(a) a water supply line including at least one perforation;
(b) a nipple drinker connected with said water supply line at each perforation to deliver a flow of water to the flock; and
(c) a pathogen inhibiting material arranged within at least one of said water supply line and said nipple drinker, said pathogen inhibiting material including at least one of a coil, mesh, ribbon, rod and wire, whereby water delivered from the system is pathogen inhibited.

2. The system according to claim 1, wherein said pathogen inhibiting material comprises copper.

3. (canceled)

4. (canceled)

5. (canceled)

6. The system according to claim 1, wherein said pathogen inhibiting material extends the length of said water supply line.

7. (canceled)

8. (canceled)

9. The system according to claim 1, wherein said nipple drinker delivers a metered supply of water.

10. The system according to claim 1, wherein said nipple drinker is removably connected with said water supply line.

11-16. (canceled)
